(19) United States
(12) Patent Application Publication
(10) Pub. No.: US 2008/0290754 A1
(43) Pub. Date: Nov. 27, 2008

(54) AC Motor

(75) Inventors: Shinji Makita, Kakamigahara-shi (JP); Masayuki Nashiki, Komaki-shi (JP); Yoshinobu Kamada, Ichinomiya-shi (JP); Eisuke Takahashi, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-city (JP)

(21) Appl. No.: 12/081,925

(22) Filed: Apr. 23, 2008

(30) Foreign Application Priority Data
May 25, 2007 (JP) 2007-139559

(51) Int. Cl. H02K 1/12

(52) U.S. Cl. 310/159; 310/156.36

(57) ABSTRACT

The motor includes a rotor including N-pole magnets and S-pole magnets located alternately along a circumferential direction of said AC motor, a stator core including a plurality of partial cores arranged coaxially along an axial direction of said AC motor each of said partial cores including a plurality of stator poles located along said circumferential direction so as to be on the same circumference, and a plurality of loop-like windings each of which extends in said circumferential direction while passing through, in said axial direction, interpole spaces between each two adjacent stator poles in said circumferential direction. The a phase angle difference between each adjacent two of said stator poles in said circumferential direction of the same one of said partial cores is set at a value smaller than 360 degrees for each of said partial cores.

### CROSS-REFERENCE TO RELATED APPLICATION

This application is related to Japanese Patent Application No. 2007-139559 filed on May 25, 2007, the contents of which are hereby incorporated by reference.

### BACKGROUND OF THE INVENTION

1. Field of the Invention

The present invention relates to an AC motor, particularly to an AC motor having a structure in which magnetic poles of a stator thereof are located along the axial direction thereof.

2. Description of Related Art

FIGS. 25 to 27 show the structure of a concentrated winding motor disclosed in Japanese Patent Application Laid-open No. 6-261513 (Patent document 1), the concentrated winding motor having a structure in which each phase coil is concentratedly wound on corresponding stator poles. FIG. 25 is a schematic axial cross section of the motor, FIG. 26 is a schematic circumferential cross section of the motor, and FIG. 27 is a schematic circumferential development of the stator of the motor.

The conventional concentrated winding motor as disclosed in Patent document 1 has problems in that the structure thereof is complicated because each winding has to be wound around each stator pole. Furthermore, since the windings have to be located at the bottoms of the slots, winding work is difficult, which causes the production efficiency to be lowered. In addition, the conventional concentrated winding motor has problems due to its structure, namely that it is difficult to make it compact in size, difficult to realize highly efficient productivity, and difficult to manufacture it at low cost.

To solve these problems, the inventor of this application proposed an AC motor shown in Japanese Patent application Laid-open No. 2005-160285 (Patent document 2).

FIGS. 28 to 32 show the structure of this AC motor. FIG. 28 is a schematic axial cross section of the motor, FIG. 29 is a schematic radial cross section of the motor, and FIG. 30 is a schematic circumferential development of the stator of the motor, FIG. 31 is a schematic circumferential development of the motor, and FIG. 32 is a schematic circumferential development of two phase windings of a stator coil of the motor.

Compared to the AC motor shown in Patent document 1, the AC motor shown in Patent document 2 can be manufactured at less cost, and can have a high efficiency, and produce a high torque, for the reasons set forth below.

The AC motor shown in Patent document 2 includes a rotor in which N-poles and S-poles are located alternately along the circumferential direction, n partial cores each of which includes a plurality of stator poles located along the circumferential direction, and located so as to be shifted one another with respect to the circumferential positions and the axial positions of their stator poles, and a plurality of loop-like windings formed so as to extend along the circumferential direction, each of the loop-like windings being located adjacent to a corresponding one of the n partial cores in the axial direction.

The stator poles constituting the same partial core are located on the same circumference. If it is assumed that windings are respectively wound around stator poles of each partial core, the windings located in a space between two adjacent stator poles of the same partial core pass such currents as to generate magnetomotive forces which have opposite directions, and accordingly cancel out each other. Hence, equivalently, no current flows through the space between these two adjacent stator poles. Accordingly, in the case of the AC motor of the type in which a plurality of the partial cores of different phases are located coaxially along the axial direction, it is possible to use the loop-like windings each of which is located axially adjacent to a corresponding one of the partial cores.

In consequence, since the windings between the stator poles located in the circumferential direction can be eliminated, the AC motor shown in Patent document 2 can have a high efficiency and produce a high torque compared to the conventional AC motor having such windings. In addition, the elimination of the windings between the stator poles enables a multi-pole structure, improvement of the productivity, and reduction of the production cost because of its simple winding structure. Furthermore, since the partial cores are symmetrical and coaxially located in the motor, deformation of the stator or distortion in each component of the motor due to a magnetic attraction force between the rotor and the stator can be reduced, to thereby reduce vibration and noise of the motor.

However, the AC motor disclosed in Patent document 2 has a problem in that since magnetic flux flows three-dimensionally in this motor, it is difficult to form its magnetic core by laminating electrical steel sheets because of the magnetic anisotropy thereof. Although, the dust core (powder magnetic core) is known as a magnetic core with no magnetic anisotropy, it is expensive, and is inferior to the magnetic core formed by laminating electrical steel sheets in magnetic characteristics and strength.

### SUMMARY OF THE INVENTION

The present invention provides an AC motor comprising:

a rotor including N-pole magnets and S-pole magnets located alternately along a circumferential direction of the AC motor;

a stator core including a plurality of partial cores arranged coaxially along an axial direction of the AC motor, each of the partial cores including a plurality of stator poles being located along the circumferential direction so as to be on the same circumference; and

a plurality of loop-like windings each of which extends in the circumferential direction while passing through, in the axial direction, interpole spaces between each two adjacent stator poles in the circumferential direction;

wherein a phase angle difference between each two adjacent stator poles in the circumferential direction of the same one of the partial cores is set at a value smaller than 360 degrees for each of the partial cores.

According to the present invention, it is possible to improve the productivity and performance characteristics of an AC motor of the type in which a plurality of the partial cores of different phases are located coaxially along the axial direction of the AC motor.

Other advantages and features of the invention will become apparent from the following description including the drawings and claims.

### BRIEF DESCRIPTION OF THE DRAWINGS

In the accompanying drawings:

FIG. 1 is a schematic axial cross section of an AC motor of an embodiment of the invention;

FIG. 2 is a diagram showing schematic cross sections of the motor along A-A, along B-B, and along C-C in FIG. 1;

FIG. 3 is a schematic circumferential development of stator poles of the motor shown in FIG. 1;

FIG. 4 is a schematic circumferential development of a rotor of the motor shown in FIG. 1;

FIG. 5 is a schematic circumferential development of loop-like windings of the motor shown in FIG. 1;

FIG. 6 is a schematic circumferential development of loop-like windings of a variant of the first embodiment;

FIG. 7 is a schematic circumferential development of stator poles of an AC motor of a variant of the embodiment;

FIG. 8 is a schematic circumferential development of loop-like windings of the motor shown in FIG. 7;

FIG. 9 is a schematic circumferential development of stator poles of a variant the motor shown in FIG. 7;

FIG. 10 is a schematic circumferential development of stator poles of a variant of the motor shown in FIG. 7;

FIG. 11 is a schematic circumferential development of stator poles of a variant of the motor shown in FIG. 7;

FIG. 12 is a schematic circumferential development of stator poles of a variant of the motor shown in FIG. 7;

FIG. 13 is a schematic circumferential development of stator poles of a variant of the motor shown in FIG. 7;

FIG. 14A is a schematic circumferential development of stator poles of a variant the motor shown in FIG. 7;

FIG. 14B is a schematic circumferential development of loop-like windings of the variant shown in FIG. 14A;

FIG. 15A is a schematic circumferential development of stator poles of a variant the motor shown in FIG. 7;

FIG. 15B is a schematic circumferential development of loop-like windings of the variant shown in FIG. 15A;

FIG. 16A is a schematic circumferential development of stator poles of a variant the motor shown in FIG. 7;

FIG. 16B is a schematic circumferential development of loop-like windings of the variant shown in FIG. 16A;

FIG. 17A is a schematic circumferential development of stator poles of a variant the motor shown in FIG. 7;

FIG. 17B is a schematic circumferential development of loop-like windings of the variant shown in FIG. 17A;

FIG. 18 is a schematic circumferential development of stator poles of a variant of the motor shown in FIG. 7;

FIG. 19 is a schematic axial cross section showing arrangements of stator poles and loop-like windings of a variant of the motor shown in FIG. 7;

FIG. 20 is a schematic axial cross section showing arrangements of stator poles and loop-like windings of a variant of the motor shown in FIG. 7;

FIG. 21 is a schematic axial cross section showing arrangements of stator poles and loop-like windings of a variant of the motor shown in FIG. 7;

FIG. 22 is a schematic axial cross section showing arrangements of stator poles and loop-like windings of a variant of the motor shown in FIG. 7;

FIG. 23A is a schematic circumferential plan view of a stator core of a variant of the motor shown in FIG. 7;

FIG. 23B is a diagram showing a schematic axial cross section of the variant shown in FIG. 23A along A-A in FIG. 23A;

FIG. 24A is a schematic circumferential development of stator poles of a variant the motor shown in FIG. 7;

FIG. 24B is a schematic circumferential development of loop-like windings of the variant shown in FIG. 24A;

FIG. 25 is a schematic axial cross section of a conventional AC motor;

FIG. 26 is a schematic radial cross section of the AC motor shown in FIG. 25;

FIG. 27 is a schematic circumferential development of the AC motor shown in FIG. 25;

FIG. 28 is a schematic axial cross section of another conventional AC motor;

FIG. 29 is a schematic radial cross section of the AC motor shown in FIG. 28;

FIG. 30 is a schematic circumferential development of a stator of the AC motor shown in FIG. 28;

FIG. 31 is a schematic circumferential development of a rotor of the AC motor shown in FIG. 28; and

FIG. 32 is a schematic circumferential development of two phase windings of a stator coil of the AC motor shown in FIG. 28.

### PREFERRED EMBODIMENTS OF THE INVENTION

An AC motor of an embodiment of the invention is described below.

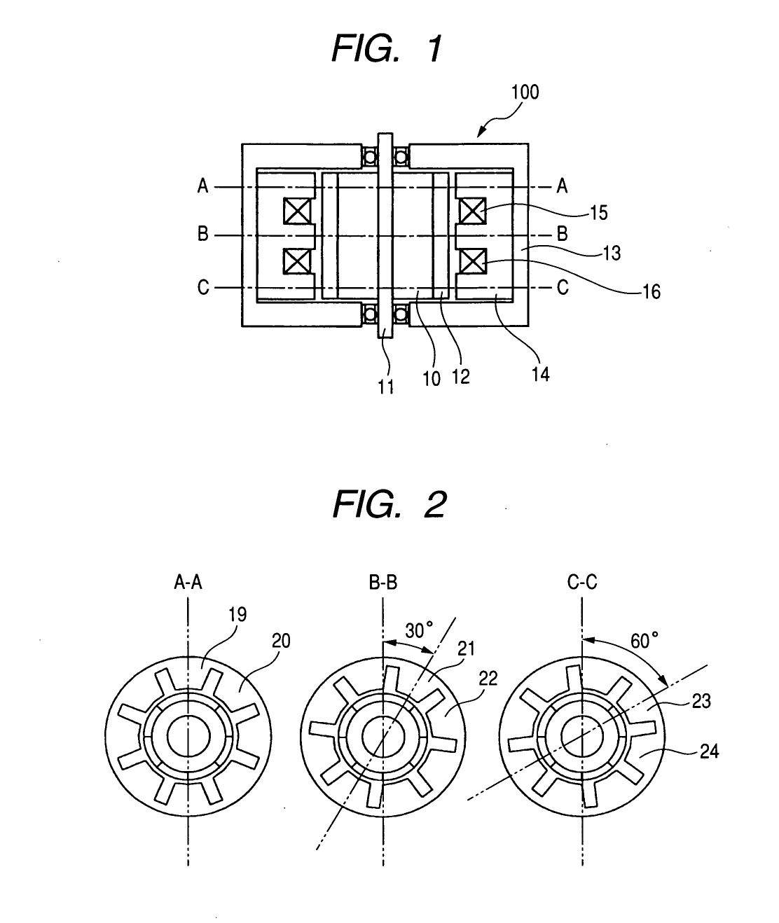

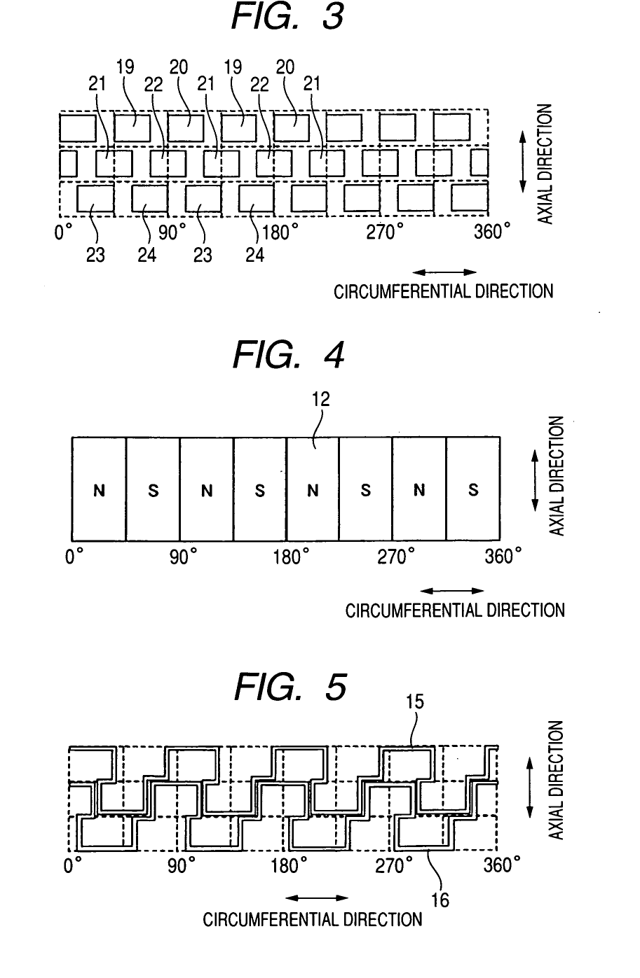

FIG. 1 is a schematic axial cross section of this motor 100. FIG. 2 is a diagram showing schematic cross sections of the motor 100 along A-A, along B-B, and along C-C in FIG. 1. FIG. 3 is a schematic circumferential development of stator poles of the motor 100. FIG. 4 is a schematic circumferential development of a rotor of the motor 100. FIG. 5 is a schematic circumferential development of loop-like windings (phase windings of two different phases) of the motor 100.

First, the basic structure of this motor 100 is explained.

The motor 100 includes a rotor 10 fixed to a rotation shaft 11 and having the SPM (surface permanent magnet) structure, in which cylindrical permanent magnet 12 is fixed to the outer periphery of the rotor 10. The rotation shaft 11 is rotatably supported by a housing 13 through bearings. As shown in FIG. 2, the permanent magnet 12 has 8 magnetic poles alternately magnetized in opposite directions along the circumferential direction thereof. Each of the angle values indicated in FIG. 2 shows a mechanical angle. In this embodiment, the electrical angle is four times the mechanical angle. The reference numeral 14 denotes a stator core. On this stator core 14, loop-like windings (phase windings) 15, 16 are wound.

The stator core 14 includes first, second, and third partial cores coaxially located so as to face the outer periphery of the rotor 10. The first partial core includes stator poles 19, 20 located alternately in the circumferential direction. The second partial core includes stator poles 21, 22 located alternately in the circumferential direction. The third partial core includes stator poles 23, 24 located alternately in the circumferential direction. The first partial core is located at the position of the line A-A in FIG. 1, that is, at one end portion of the stator core 14 in the axial direction. The second partial core is located at the position of the line B-B in FIG. 1, that is, at a middle portion of the stator core 14 in the axial direction. The third partial core is located at the position of the line C-C in FIG. 1, that is, at the other end portion of the stator core 14 in the axial direction.

As shown in FIG. 2, each of the first to third partial cores has 8 poles. Accordingly, the phase angle between the stator poles 19, 20, between the stator poles 21, 22, and between the stator poles 23, 24 is 45 degrees in mechanical angle (180 degrees in electrical angle). The second partial core is shifted by 30 degrees in mechanical angle (120 degrees in electrical angle) from the first partial core. The third partial core is shifted by 30 degrees in mechanical angle (120 degrees in electrical angle) from the second partial core. Each of the stator poles included in the first, second, or third partial cores is made of a soft magnetic square bar-like member having a predetermined length in the circumferential direction, and a predetermined width in the axial direction.

As shown in FIG. 2, the stator poles included in the same partial core are magnetically short-circuited to one another in the circumferential direction through a ring-shaped yoke portion of the partial core at their base end portions. The ring-shaped yoke portions of the first to third partial cores are magnetically short-circuited to one another in the axial direction by a ring-shaped yoke portion located radially outside the loop-like windings 15, 16. The partial cores may be dust cores. However, they are not limited thereto. For example, each of the partial cores may be a collective of a plurality of further smaller partial cores.

As explained above, the stator core 14 is constituted of three partial cores as stator cores disposed along the axial direction, the phase angle between the two adjacent stator poles of each of these stator cores being set at 120 degrees in electrical angle. Accordingly, in case a loop-like winding is wound on each of the partial cores, since magnetic flux flow between the partial cores is not indispensable, if the magnetic resistance of a magnetic circuit in the axial direction is high, it does not cause any critical problem. Hence, the stator core 14 can be formed by laminating electrical steel sheets.

Next, the loop-like windings 15, 16 are explained with reference to FIG. 5. In this embodiment, each of the loop-like windings 15, 16 has a unique winding pattern.

The loop-like winding 15 is a wave winding which passes through a space between the adjacent stator poles 19, 20, and a space between the adjacent stator poles 21, 22 downwardly in FIG. 5. Thereafter, the loop-like winding 15 passes through a space between another set of adjacent stator poles 22, 21, and a space between another set of adjacent stator poles 20, 19 upward in FIG. 5 to return to the initial position in the axial direction, these spaces being adjacent in the circumferential direction to the spaces through which the loop-like winding 15 has already passed. This pattern of winding is repeated until the loop-like winding 15 makes a turn in the circumferential direction.

Likewise, the loop-like winding 16 is a wave winding which passes through a space between the adjacent stator poles 22, 21 and a space between the adjacent stator poles 24, 23 downwardly in FIG. 5. Thereafter, the loop-like winding 16 passes through a space between another set of adjacent stator poles 23, 24 and a space between another set of adjacent stator poles 21, 22 upward in FIG. 5 to return to the initial position in the axial direction, these spaces being adjacent in the circumferential direction to the spaces through which the loop-like winding 16 has already passed. This pattern of winding is repeated until the loop-like winding 16 makes a turn in the circumferential direction.

In this embodiment, around the stator poles 19, 20 of the first partial core (which may be regarded, for example, as a 2-pole stator core of U-phase), the loop-like winding 15 (which may be regarded as a U-phase wave winding) generates a U-phase magnetic field. Likewise, around the stator poles 23, 24 of the third partial core (which may be regarded, for example, as a 2-pole stator core of W-phase), the loop-like winding 16 (which may be regarded as a W-phase wave winding) generates a W-phase magnetic field. The loop-like winding 15 as a U-phase winding and the loop-like winding 16 as a W-phase winding are wound on the stator poles 21, 22. Accordingly, since a combined current of a U-phase current and a W-phase current, that is, an inverted V-phase current flows around the stator poles 21, 22 of the second partial core, a V-phase magnetic field is generated therearound. Hence, three rotating magnetic fields spaced 120 degrees in electrical angle from one another are generated by these two loop-like windings 15, 16.

The above described embodiment of the invention provides the following advantages. In this embodiment, the phase difference between the adjacent stator poles 19, 20, the phase difference between the adjacent stator poles 21, 22, and the phase difference between the adjacent stator poles 23, 24 are 180 degrees in electrical angle. Accordingly, the two adjacent stator poles respectively face two rotor-side magnets of opposite polarity. In such a positional configuration of the stator poles, since each of the two adjacent stator poles are magnetically balanced to each other, it is possible to reduce cogging torque, and torque ripple due to the cogging torque.

In addition, since the magnetic flux flowing between each two adjacent stator poles in the circumferential direction is dominant, if the stator core is formed by laminating electrical steel sheets, eddy current loss can be made small, because the amount of the magnetic flux which perpendicularly interlinks with the electrical steel sheets is small.

FIG. 3 shows the case where the phase difference between the stator poles adjacent to each other in the circumferential direction is 180 degrees in electrical angle, however, it is not limited thereto. For example, stator poles the phase difference between which is 120 degrees, and stator poles the phase difference between which is 90 degrees may be combined such that a sum of magnetic fluxes interlinking with the stator poles located in the same axial position is virtually 0. Also this example provides much the same advantages as those provided by this embodiment.

In this embodiment, the phase difference between the stator poles adjacent to each other in the circumferential direction is 180 degrees in electrical angle for all the stator poles, however, it is not necessarily needed. For example, it may be 170 degrees or 190 degrees. That is, because, if the phase difference between the stator poles adjacent to each other in the circumferential direction is smaller than 360 degrees in electrical angel, since there exist stator poles having different phases in the same axial position, they are easily balanced magnetically.

As understood from the above description, also in a case where a plurality of the partial cores are tandem-located along the axial direction such that magnetic flux can flow in the axial direction, if a combined magnetic field generated by all the stator poles located in the same axial position is near to 0, since a flow of magnetic flux from one partial core to the adjacent partial core in the axial direction can be eliminated, various advantages can be obtained. In addition, if the stator poles of the same polarity of the same partial core are located symmetrically about a point, a radial magnetic force applied to this partial core can be well balanced.

In this embodiment, the stator poles located in the upper part of FIGS. 3, 5 and the winding is in such a positional relationship that the phase difference between the stator poles 19, 20 adjacent to each other in the circumferential direction is 180 degrees in electrical angle. Accordingly, if sinusoidal currents phase-shifted from each other by 180 degrees are passed through the winding spaces (interpole spaces) adjacent to each other in the circumferential direction, a maximum torque can be generated. Actually, according to the winding pattern of the loop-like winding 15 shown in FIG. 5, the currents respectively flowing through the winding spaces adjacent to each other in the circumferential direction are opposite in direction, and accordingly, these winding spaces are equivalently supplied with the currents phase-shifted from each other by 180 degrees.

The stator poles located in the bottom part of FIGS. 3, 5 and the winding is in the same positional relationship as the stator poles located in the upper part of FIGS. 3, 5. Accordingly, a maximum torque can be generated by passing a sinusoidal current to the loop-like winding 16. The positions of the stator poles located in the upper part and the positions of the stator poles located in the bottom part of FIG. 5 are shifted from each other by 120 degrees. Accordingly, the loop-like winding 15 and the loop-like winding 16 are respectively supplied with currents having a phase difference of 120 degrees therebetween.

The positions of the stator poles located in the middle part of FIG. 5 are shifted by 120 degrees with respect to the positions of the stator poles located in the upper part and also with respect to the positions of the stator poles located in the bottom part. Accordingly, by passing, to the winding spaces of the stotor poles located in the middle part, a current having a phase difference of 120 degrees with respect to the current flowing through the winding spaces of the stator poles located in the upper part and the current flowing through the winding spaces of the stator poles located in the bottom part, a maximum torque can be generated. The loop-like winding 15 and the loop-like winding 16 are located in an overlapped manner in the winding spaces of the stator poles located in the middle part. Since the currents respectively flowing through the loop-like winding 15 and the loop-like winding 16 are shifted in phase by 120 degrees from each other, a combined current of these currents is also shifted by 120 degrees to each of these currents. Hence, by passing currents shifted in phase by 120 degrees from each other to the loop-like winding 15 and the loop-like winding 16, respectively, the torque can be generated.

It is possible to employ a configuration in which the loop-like winding 15 is divided to two groups, one of which is supplied with a current of Io×sin(θ+α), the other of which is supplied with a current of −Io×sin(θ+α-120), and the loop-like winding 16 is divided to two groups, one of which is supplied with a current of Io×sin(θ+α-120), and the other of which is supplied with a current of −Io×sin(θ+α-240), where Io is a current amplitude, θ is an electrical angle, and α is a current phase. Also in this configuration, the torque can be generated.

### Variant

As shown in FIG. 1, if the axial width of each of the stator poles is the same at any radial position thereof, since it is possible to form stator poles simply by laminating a certain number of electrical steel sheets, the productivity can be made high. If all the stator poles have the same circumferential width, since it is possible to form all the partial cores by laminating electrical steel sheets of the same shape, the productivity can be made high. However, they may have different circumference widths depending on the technique used to laminate them.

### Variant

FIG. 6 is a circumferential development of a stator coil including three phase windings (loop-like windings) 15, 16, 17 as a variant of the embodiment. First, a positional relationship between the stator poles located in the upper part of FIG. 6 and the winding 15 is explained. Since the phase difference between the adjacent stator poles is 180 degrees in electrical angle, if sinusoidal currents having a phase difference of 180 degrees therebetween are respectively passed to the adjacent winding spaces, a maximum torque can be generated. Actually, according to the winding pattern shown in FIG. 6, the currents respectively flowing through the adjacent winding spaces are opposite in direction, and accordingly, these winding spaces are equivalently supplied with the currents phase-shifted from each other by 180 degrees.

Next, a positional relationship between the stator poles located in the middle part of FIG. 6 and the winding16 is explained. Since the positional relationship is the same as that explained above, by passing a sinusoidal current to the winding 16, a maximum torque can be generated. The positions of the stator poles located in the upper part and the positions of the stator poles located in the bottom part of FIG. 6 are shifted from each other by 120 degrees. Accordingly, the winding 15 and the winding 17 are respectively supplied with the currents having a phase difference of 120 degrees therebetween.

In this variant, by supplying the three windings 15, 16, 17 with the currents phase-shifted by 120 degrees from one another, a torque can be generated.

From a different viewpoint, it can be said that, in this variant, the stator poles 19, 21 surrounded by the loop-like winding 15 forms one phase, the stator poles 22, 24 surrounded by the loop-like winding 16 forms another phase, and the stator poles 20, 23 surrounded by the loop-like windings 15, 16 forms still another phase.

### Variant

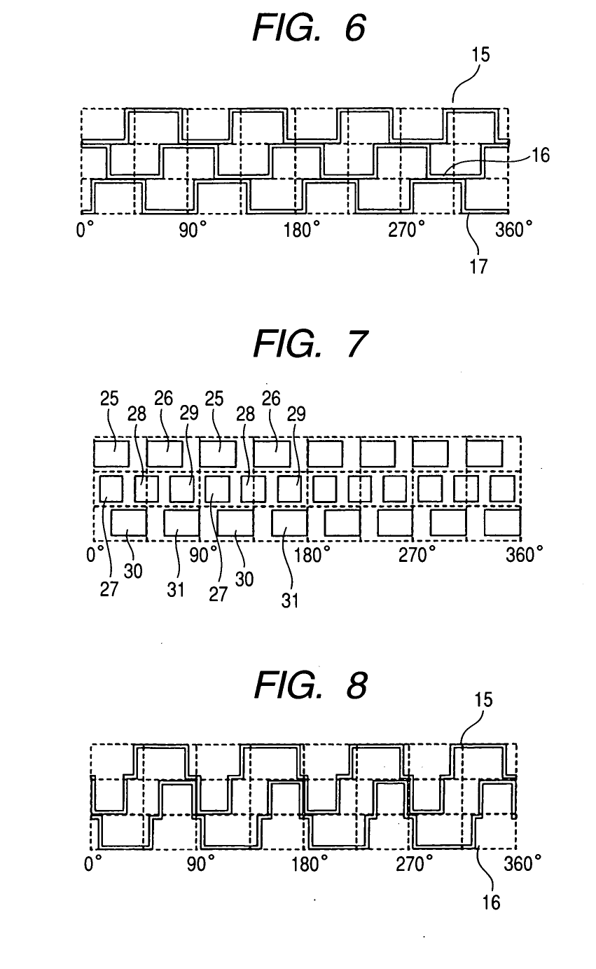

Next, an AC motor of a variant of the embodiment is described with reference to FIG. 7 and FIG. 8. FIG. 7 is a schematic circumferential development of the stator poles, and FIG. 8 is a schematic circumferential development of the loop-like windings of this embodiment.

First, a positional relationship between the stator poles 25, 26 located in the upper part of FIG. 7 and the winding 15 is explained. The phase difference between the adjacent stator poles 25, 26 is 180 degrees in electrical angle. Accordingly, if sinusoidal currents having a phase difference of 180 degrees therebetween are respectively passed to the adjacent winding spaces, a maximum torque can be generated. Actually, according to the winding pattern shown in FIG. 8, the currents respectively flowing through the adjacent winding spaces are opposite in direction, and accordingly, these winding spaces are equivalently supplied with the currents phase-shifted from each other by 180 degrees.

Next, a positional relationship between the stator poles 30, 31 located in the bottom part of FIG. 8 and the winding16 is explained. Since the positional relationship is the same as that explained above, by passing a sinusoidal current to the winding 16, a maximum torque can be generated. The positions of the stator poles located in the upper part and the positions of the stator poles located in the bottom part of FIG. 8 are shifted from each other by 120 degrees. Accordingly, the winding 15 and the winding 16 are respectively supplied with the currents having a phase difference of 120 degrees therebetween.

Next, the stator poles 27, 28, 29 located in the middle part of FIG. 8 is explained. Unlike the stator poles located in the upper part and the bottom part, the phase difference between the adjacent stator poles located in the middle part is 120 degrees in electrical angle. Accordingly, if sinusoidal currents having a phase difference of 120 degrees therebetween are respectively passed to the adjacent winding spaces, a maximum torque can be generated. Since the combined current of the current flowing through the winding 15 and the current flowing through the winding 16 is shifted in phase by 120 degrees from each of these currents, the current passing through the winding space at which both of the windings 15, 16 are located is shifted in phase by 120 degrees to the current passing through the adjacent winding space at which only one of the windings 15, 16 is located.

Accordingly, by passing sinusoidal currents having a phase difference of 120 degrees therebetween, the torque can be generated. According to this embodiment, since the winding has no circumferentially overlapped portions, the winding length can be shortened compared to the embodiment (for comparison, see FIG. 5).

From a different viewpoint, it can be said that, in this embodiment, the stator poles 25, 27 surrounded by the winding 15 forms one phase, the stator poles 29, 31 surrounded by the winding 16 forms another phase, and the stator poles 26, 28, 30 surrounded by the windings 15, 16 forms still another phase.

### Variant

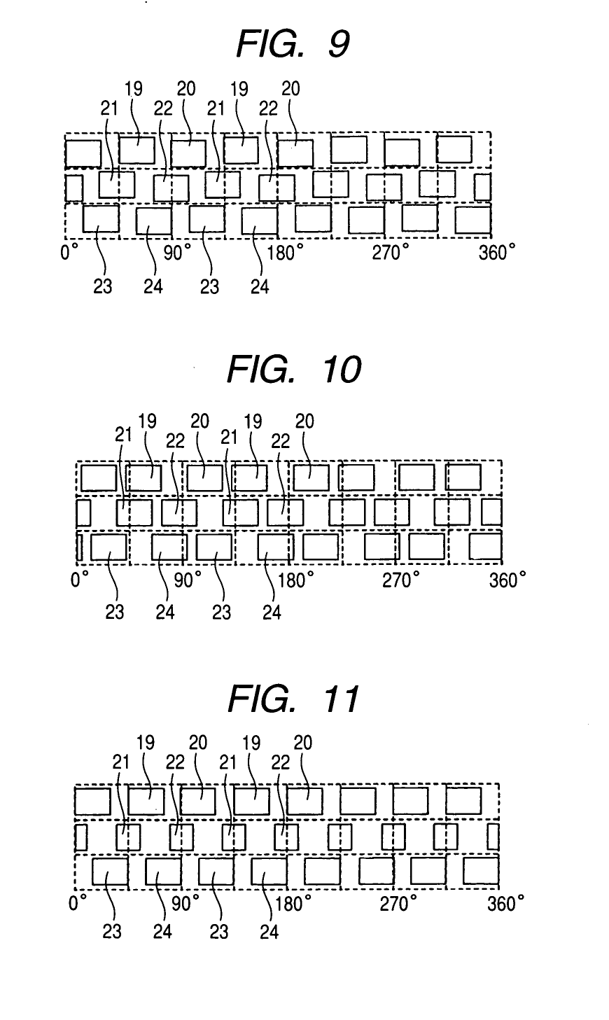

As shown in FIG. 9, if the stator poles 20, 22, 23, at each which the windings are located adjacently to each other at one side thereof in the axial direction, are shifted in the axial direction to shorten the axial lengths of the windings, it is possible to shorten the winding length. By shifting these stator poles in this way within the limits that the magnetic balance does not come undone significantly, it becomes possible to shorten the winding length to thereby reduce the copper loss of the AC motor.

### Variant

As shown in FIG. 10, if the stator poles 19, 21 of the same phase, the stator poles 22, 24 of the same phase, and the stator poles 20, 23 of the same phase are shifted in the circumferential direction such that each of these two stator poles of the same phase come close to each other keeping within the limits where the magnetic balance does not come overly undone, it becomes possible to shorten the winding length to thereby reduce the copper loss of the AC motor.

Incidentally, in the case of FIG. 3, if the circumferential width of one stator pole exceeds 120 degrees in electrical angle, the circumferential combined width of the stator poles of the same phase exceeds 180 degrees in electrical angle. If so, since the N-pole magnet and S-pole magnet of the rotor face the stator poles of the same phase at the same time. This causes reduction of the output torque. By shifting the stator poles in the manner as described above, it becomes possible to reduce the circumferential combined width of the stator pole of the same phase to within 180 degrees, to thereby prevent the output torque reduction.

### Variant

The effect described above can be also obtained by shortening the circumferential width of the stator poles. For example, as shown in FIG. 11, by reducing the circumferential width of the stator poles 21, 22 located in the middle part, it becomes possible to reduce the combined width of the stator poles of the same polarity to within 180 degrees in electrical angle.

### Variant

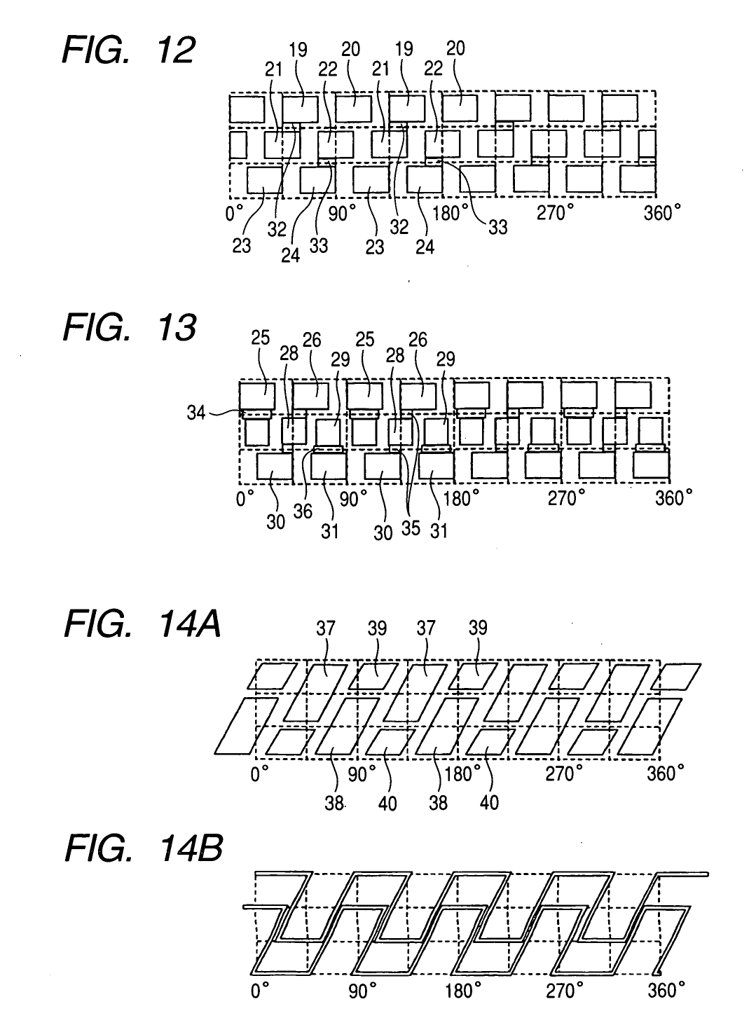

As shown in FIG. 12, in the case of FIG. 3, if magnetic substances 32, 33 are disposed in the interpole spaces through which the winding does not pass, in order to increase the number of portions through which magnetic flux flows, it becomes possible to suppress magnetic saturation, and to improve the torque characteristic of the AC motor. Likewise, as shown in FIG. 13, in the case of FIG. 7, if magnetic substances 34, 35, 36 are disposed in the interpole spaces through which the winding does not pass, in order to increase the number of portions through which magnetic flux flows, the same advantage as described above can be obtained. The stator poles may have a shape of a combination of bar-like members, or chamfered bar-like members.

### Variant

As shown in FIGS. 14A, 14B, the magnet surface, that is, the surface facing the rotor of each of the stator poles may have a parallelogram shape. In this case, since the winding does not have rectangularly bent portions, the winding length can be reduced, to thereby reduce the copper loss and the use amount of the winding. In addition, if the magnet surfaces of the stator poles are parallelogram-shaped, since the change rate of the rotation angle of the magnetic fluxes flowing into the stator poles becomes gentle, the torque ripple can be reduced.

### Variant

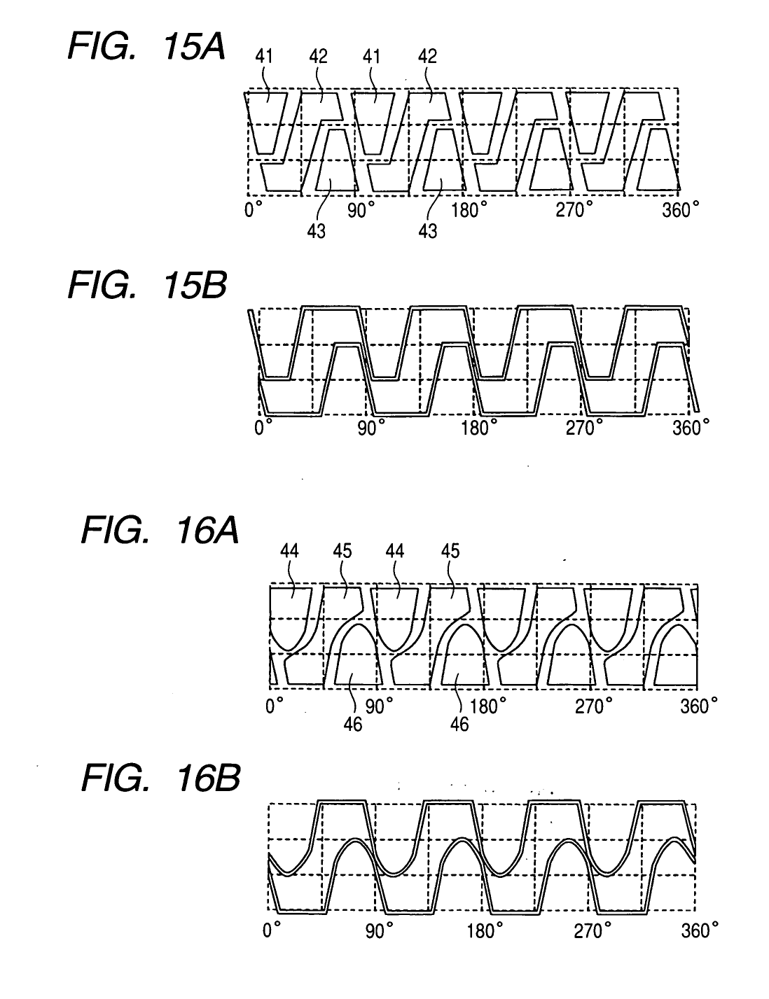

As shown in FIGS. 15A, 15B, the magnet surface, that is, the surface facing the rotor of each of the stator poles may have a trapezoidal shape. In this case, since the winding does not have rectangularly bent portions, the winding length can be reduced, to thereby reduce the copper loss and the use amount of the winding. In addition, according to this variant in which the magnet surfaces of the stator poles have a trapezoidal shape, since the change rate of the rotation angle of the magnetic fluxes flowing into the stator poles becomes gentle, the torque ripple can be reduced.

### Variant

As shown in FIGS. 16A, 16B, the magnet surface of each of the stator poles may have such a shape that its axial width changes in roughly a sinusoidal manner along the circumferential direction. In this case, since the winding does not have rectangularly bent portions, the winding length can be reduced, to thereby reduce the copper loss and the use amount of the winding.

Here, when the U-phase magnetic flux and the W-phase magnetic flux flowing through the stator pole located at one axial end of the stator are represented by ψu, ψw, respectively, ψu=ψ0sin θ, and ψw=ψ0sin(θ-120), when the rotor rotates, where ψ0 is a flux amplitude, and θ is a flux phase. Since a sum of the U-phase, V-phase, and W-phase magnetic fluxes is always 0, the equation of ψu+ψv+ψw=0 holds. Accordingly, the V-phase magnetic flux phiv flowing through the stator pole located at the axially middle part of the stator is equal to −(ψu+ψw) irrespective of its shape. In consequence, since ψv=ψ0sin(θ-240), the U-phase, V-phase, and W-phase magnetic fluxes having the same amplitude and phase-shifted by 120 degrees from one another flow respectively through the stator poles located at the upper part, the stator poles located at the middle part, and the stator poles located at the bottom part of FIG. 16A. Hence, although only the stator poles located in the upper and bottom parts of FIG. 16A have the sinewave-like shapes, it can be said that also the stator poles located in the middle part of FIG. 16 equivalently have the sinewave-like shapes. According to this variant in which the magnet surface of each of the stator poles has such a shape that its axial width changes in roughly a sinusoidal manner along the rotating direction of the rotor, since the change rate of the rotation angle of the magnetic fluxes flowing into the stator poles changes sinusoidally, the torque ripple can be reduced.

### Variant

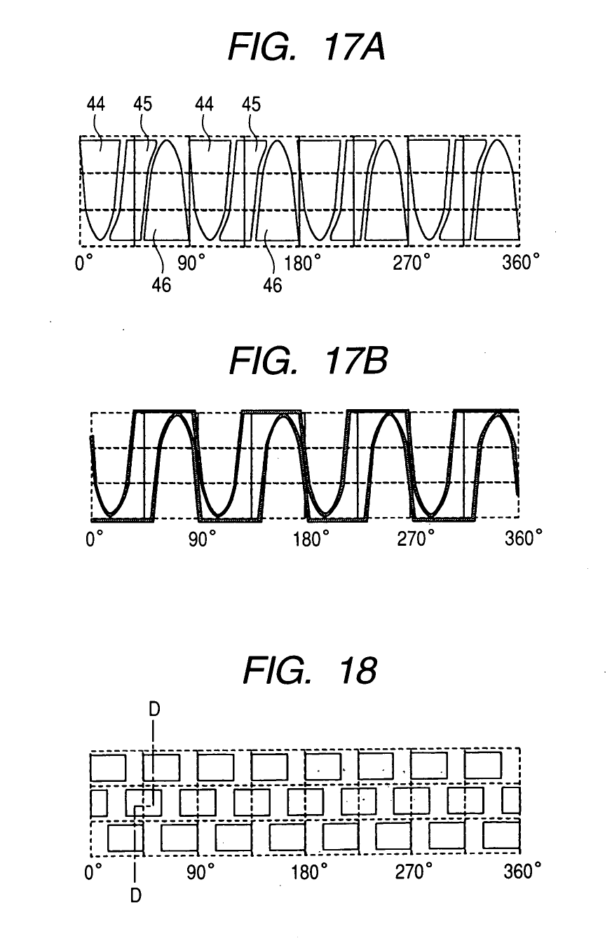

FIGS. 17A, 17B show a modification of the variant shown in FIGS. 16A, 16B. As shown in FIG. 17A, the stator poles 44, 46 at both axial end sides of the stator may have an axial width roughly equal to the axial width of the permanent magnet 12 of the rotor 10. Also in this case, the magnet surface of each of the stator poles has such a shape that its axial width changes in roughly a sinusoidal manner along the circumferential direction. Accordingly, according to this variant, the torque ripple can be further reduced.

### Variant

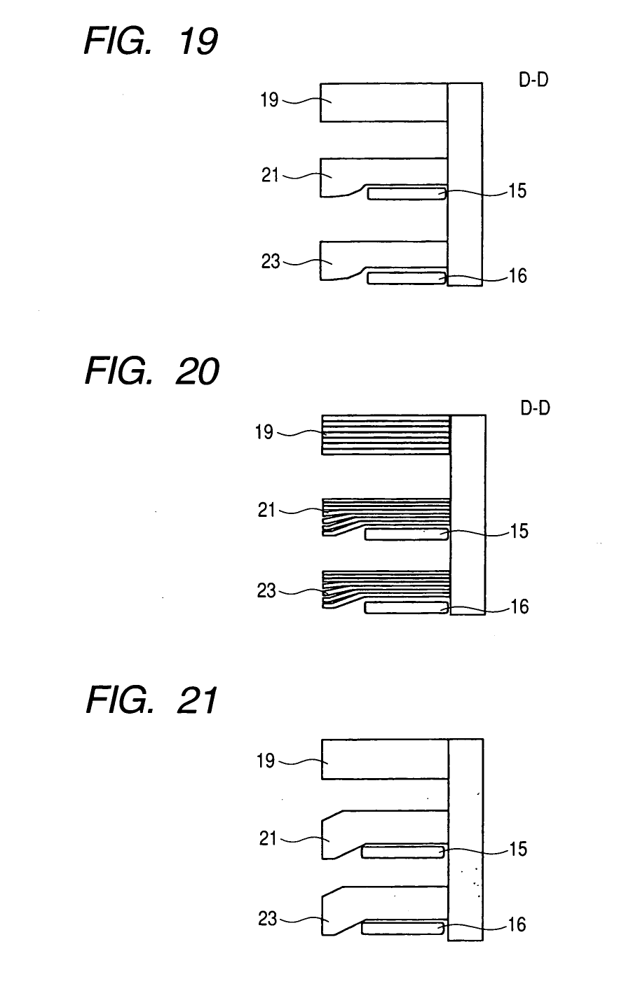

As shown in FIG. 18 and FIG. 19, in this variant, in the stator poles at each of which the windings adjoin in the axial direction, the axial width of a part of the stator pole, on which the winding is wound is reduced, so that it has a recess portion in which the winding is located. This configuration makes it possible to reduce the winding length. Since this configuration can reduce or eliminate hanging-out of the winding in the axial direction located at the axial end side of the stator, according to this variant, the axial length of the AC motor can be reduced. As shown in FIG. 20, the axial width of the part of the stator pole, on which the winding is wound, may be reduced by bending the electrical steel sheets laminated to form the stator pole.

### Variant

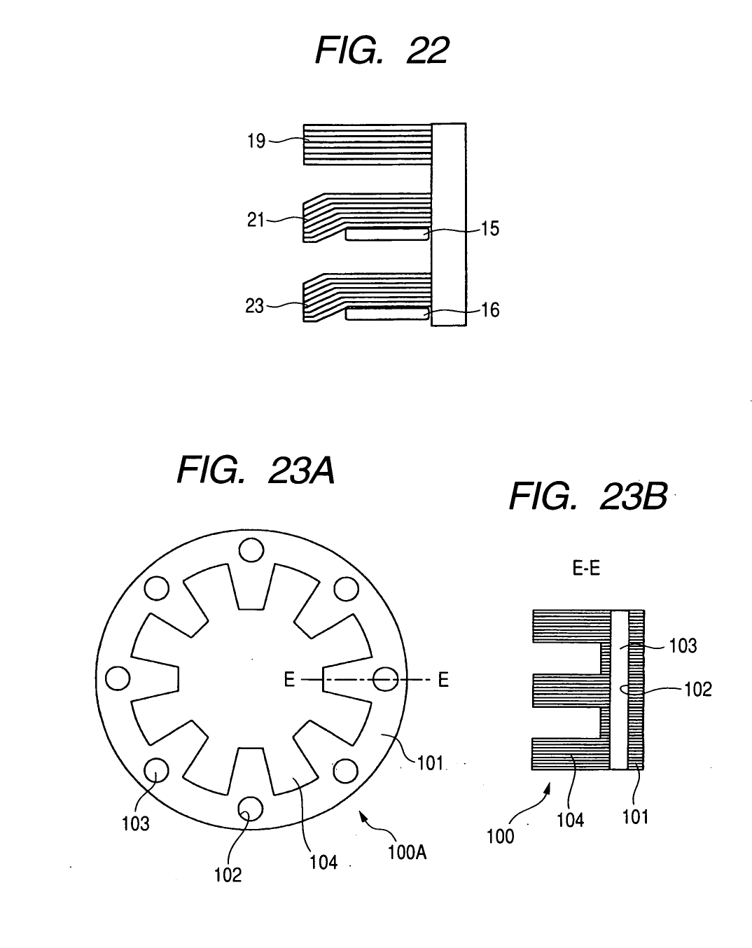

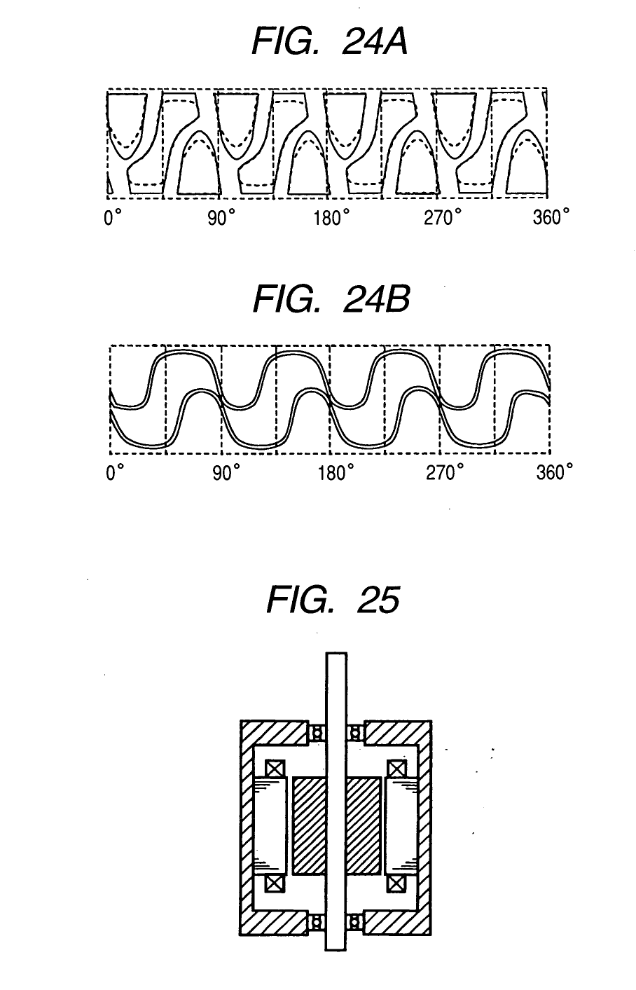

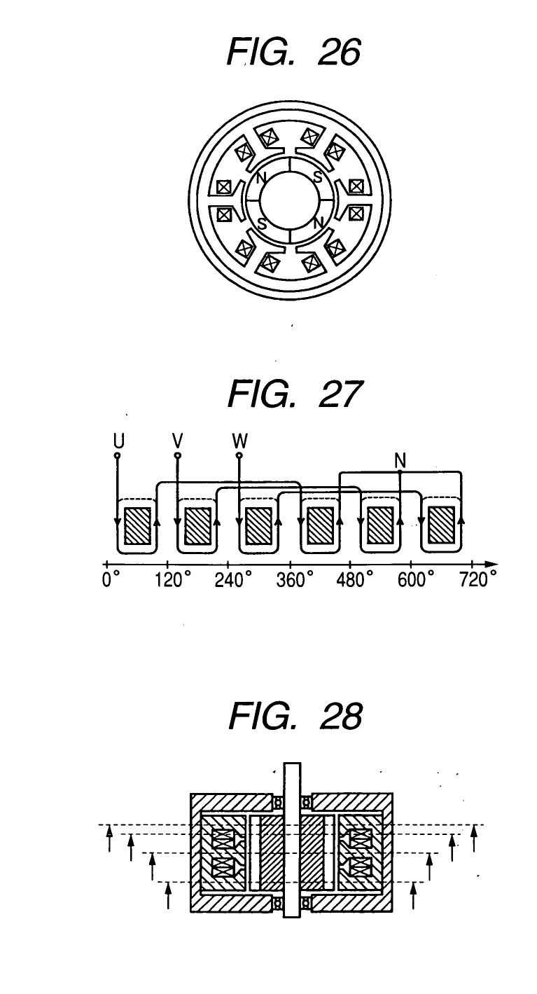

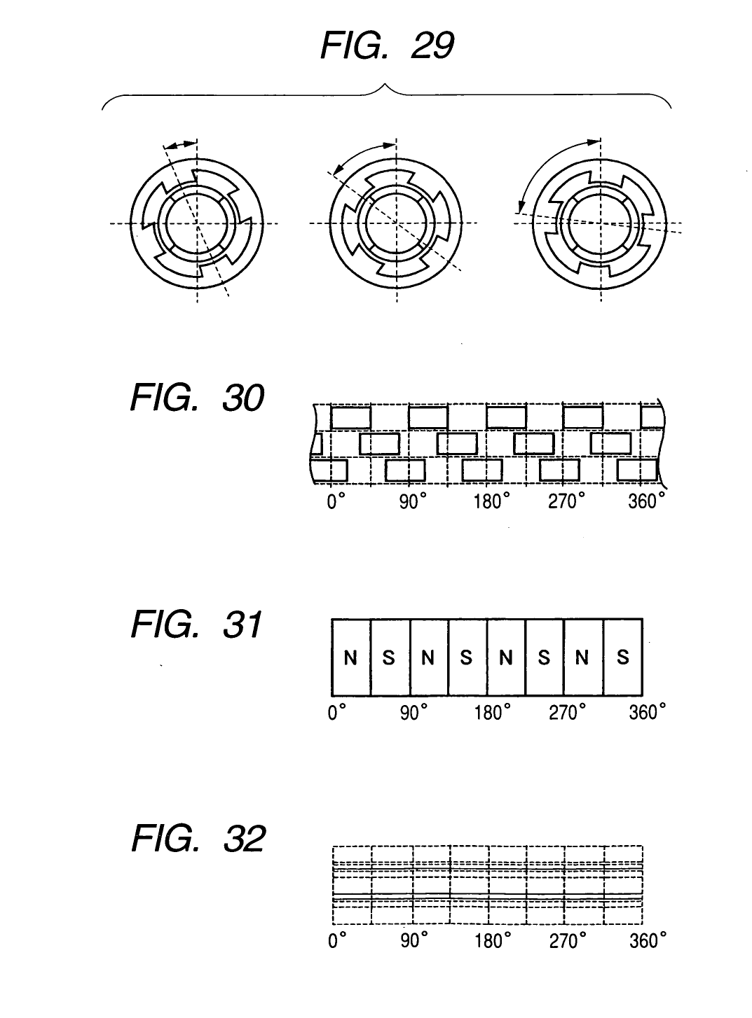

As shown in FIG. 21, in this variant, in the stator poles at each of which the windings adjoin in the axial direction, the axial position of a part of the stator pole, on which the winding is wound is shifted in the direction opposite to the winding such that it has a recess portion in which the winding is located. This configuration makes it possible to reduce the winding length. Since this configuration reduces or eliminates hanging-out of the winding in the axial direction located at the axial end side of the stator, according to this variant, the axial length of the AC motor can be reduced. As shown in FIG. 22, the axial width of the part of the stator pole, on which the winding is wound may be reduced by bending the electrical steel sheets laminated to form the stator pole.

### Variant

If a part of the stator formed by laminating electrical steel sheets is made of an isotropic soft magnetic material, it is possible to reduce the eddy current of the stator, because the axial magnetic flux in the stator concentrate on this part. As shown in FIGS. 23A, 23B, in this variant, a yoke portion 101 of a stator core 100A of the type in which the stator poles are located along the axial direction is formed with 8 through holes 102 into each of which a round bar 103 made of an isotropic soft magnetic material is fitted and fixed. Preferably, the through hole 102 is located radially outside the stator pole 104 in view of the strength and flux flow. Also, it is desirable to provide the stator core 100A with a non-magnetic portion such as a slit to block the eddy current in the electrical steel sheet.

### Variant

Various modifications of the shape of the stator pole have been explained above. Any one of or combination of these modifications can be used in accordance with usage conditions such as the size, number of poles, intended use, and use constraints, for example as shown in FIGS, 24A, 24B. It should be noted that this invention can be advantageously applied particularly to a thin motor, because the invention make it possible to reduce or eliminate hanging-out of the windings (called in conventional motors, coil ends) in the axial direction. Although the rotor used in the embodiment and variants described above is of the type having magnets at its surface, it may be of the type having magnets embedded therein, or may be combined with a different type of rotor. Also, although the above described embodiment and variants of the invention are directed to an AC motor of the inner rotor type, the present invention is applicable to an AC motor of the outer rotor type. Since the AC motor of the outer rotor type has such a characteristic that it can be made thin easily, have short windings, and have a large rotor diameter, the advantages of the present invention are enhanced when applied to the AC motor.

Since the winding is a meandering winding in the embodiment and variants, it can be easily formed, for example, by fitting a molded winding into winding spaces, or by using an aluminum winding which is soft and easy to shape.

The above explained preferred embodiments are exemplary of the invention of the present application which is described solely by the claims appended below. It should be understood that modifications of the preferred embodiments may be made as would occur to one of skill in the art.

What is claimed is:

1. An AC motor comprising:
a rotor including N-pole magnets and S-pole magnets located alternately along a circumferential direction of said AC motor;
a stator core including a plurality of partial cores arranged coaxially along an axial direction of said AC motor, each of said partial cores including a plurality of stator poles being located along said circumferential direction so as to be on the same circumference; and
a plurality of loop-like windings each of which extends in said circumferential direction while passing through, in said axial direction, interpole spaces between each two adjacent stator poles in said circumferential direction;
wherein a phase angle difference between each two adjacent stator poles in said circumferential direction of the same one of said partial cores is set at a value smaller than 360 degrees for each of said-partial cores.

2. The AC motor according to claim 1, wherein all of said stator poles have substantially the same axial length.

3. The AC motor according to claim 1, wherein in each of said partial cores, said stator poles are included in one of a first group and a second group, said stator poles included in said first group and said stator poles in said second group are alternately located in said circumferential direction, and a phase difference in said circumferential direction between said stator poles included in said first group and said stator poles in said second group is substantially 180 degrees in electrical angle, each of said loop-like windings being a wave winding passing through, in said axial direction, interpole spaces formed at a predetermined pitch by said stator poles included in said first group and said stator poles included in said second group, and wherein said

4. The AC motor according to claim 3, wherein said stator core includes three of said partial cores arranged along said axial direction, and includes three of said loop-like windings respectively wound on said three of said partial cores.

5. The AC motor according to claim 3, wherein a first one of said loop-like windings is a wave winding laid so as to pass through one of said interpole spaces of a first one of said partial cores in said axial direction so as to surround one of said stator poles of said first one of said partial cores and one of said stator poles of a second one of said partial cores, said first and second ones of said partial cores being adjacent to each other in a first direction parallel to said axial direction, pass through one of said interpole spaces of said second one of said partial cores in a second direction opposite to said first direction, and pass through one of said interpole spaces of said first one of said partial cores in said second direction, and
wherein a second one of said loop-like windings is a wave winding laid so as to pass through one of said interpole spaces of said second one of said partial cores in said axial direction so as to surround one of said stator poles of said second one of said partial cores and one of said stator poles of a third one of said partial cores, said second and third ones of said partial cores being adjacent to each other in said first direction, pass through one of said interpole spaces of said third one of said partial cores in said second direction, and pass through one of said interpole spaces of said second one of said partial cores in said second direction,
said first and second ones of said loop-like windings being laid so as not to cross each other.

6. The AC motor according to claim 3, wherein, in each of said partial cores, an axial position of said stator poles included in said first group is different from an axial position of said stator poles included in said second group.

7. The AC motor according to claim 3, wherein said stator core includes three of said partial cores as first, second, and third partial cores arranged along said axial direction, and includes two of said loop-like windings as first and second loop-like windings, said first loop-like winding being wound on said first and second partial cores, said second loop-like winding being wound on said second and third partial cores.

8. The AC motor according to claim 7, wherein said first and third partial cores are located respectively at both axially end portions of said stator core, and said second partial core is located at an axially middle portion of said stator core, said stator poles of said first and third partial cores being located along said circumferential direction at a pitch of 180 degrees in electrical angle, said stator poles of said second partial cores being located along said circumferential direction at a pitch of 120 degrees in electrical angle, said interpole spaces of said second partial core including ones through which only said first loop-like winding passes, ones through which only said second loop-like winding passes, and ones through which said first and second loop-like windings pass.

9. The AC motor according to claim 1, wherein circumferential positions of some of said stator poles are shifted by a predetermined phase angle in said circumferential direction.

10. The AC motor according to claim 1, wherein, in each of said partial cores, said stator poles have at least two kinds of circumferential width.

11. The AC motor according to claim 1, wherein a soft magnetic substance is disposed in an axial space between two of said stator poles which are adjacent in said axial direction, and included respectively in two of said partial cores.

12. The AC motor according to claim 1, wherein a surface of each of said stator poles facing said rotor has a parallelogram shape.

13. The AC motor according to claim 1, wherein a surface of each of said stator poles facing said rotor has a trapezoidal shape.

14. The AC motor according to claim 1, wherein a surface of each of said stator poles facing said rotor has an edge changing in roughly a sinusoidal manner with respect to said circumferential direction, so that an axial width of each of said stator poles facing said rotor changes in roughly a sinusoidal manner along said circumferential direction.

15. The AC motor according to claim 1, wherein, of a radial portion of each of said stator poles extending in a radial direction of said stator core, a part facing said loop-like winding in said axial direction is dented with respect to a front end part of said radial portion, which does not face said loop-like winding.

16. The AC motor according to claim 1, wherein of a radial portion of each of said stator poles extending in a radial direction of said stator core, a front end part which does not face said loop-like winding has a wide width in said axial direction compared to a part of said portion which faces said loop-like winding in said axial direction.

17. The AC motor according to claim 1, wherein said stator core includes a member made of isotropic soft magnetic material located at a yoke portion of said stator core so as to extend in said axial direction.

18. The AC motor according to claim 17, wherein said stator core includes electrical steel sheets laminated in said axial direction so as to form said partial cores and said yoke portion magnetically connecting said partial cores, said yoke portion being formed with at least one through hole extending in said axial direction, said through hole being filled with said member made of isotropic soft magnetic material.
